(19) United States
(12) Patent Application Publication
(10) Pub. No.: US 2008/0223599 A1
(43) Pub. Date: Sep. 18, 2008

(54) Electrical Junction Box

(76) Inventors: Raymond Shen, Peachtree, GA (US); Matthew W. Conger, East Point, GA (US); Christian D. Baker, Peachtree City, GA (US); Christopher G. Ladewig, Fayetteville, GA (US)

Correspondence Address: KING & SPALDING LLP, 1180 PEACHTREE STREET, ATLANTA, GA, 30309-3521, US

(21) Appl. No.: 12/103,644

(22) Filed: Apr. 15, 2008

Related U.S. Application Data
(63) Continuation-in-part of application No. 29/260,340, filed on May 23, 2006, now Pat. No. D566657.

(51) Int. Cl. H01H 9/02

(52) U.S. Cl. 174/58

(57) ABSTRACT

An electrical junction box for securing an electrical device substantially behind the exterior of a building structure to protect it from rain and other elements includes a box-shaped housing having a top wall, a bottom wall, side walls, a back wall, a front opening, a front edge surrounding the front opening, and a cavity for receiving the electrical device therein. The housing includes a boss extending from the back wall into the cavity. The boss has a forward-facing surface configured to receive fasteners to attach the electrical device. The front of the electrical device is recessed within the cavity. The electrical junction box also includes a wall extending outwardly from the front edge of the front opening and configured to abut the exterior of a structure. The electrical junction box also includes a rotatably adjustable cover for closing access to the front opening of the box.

### CROSS-REFERENCE TO RELATED APPLICATIONS

The present application is a continuation-in-part of U.S. Design patent application Ser. No. 29/260,340, filed on May 23, 2006, titled “Portion of a Junction Box.” The complete disclosure of the above-identified application is hereby fully incorporated herein by reference.

### TECHNICAL FIELD

The present application relates generally to electrical junction boxes for securing an electrical device substantially behind the exterior of a building structure. More specifically, the present application relates to a unitary electrical junction box having improved weatherproof capabilities and impact protection.

### BACKGROUND

When mounting outlets for exterior applications, covered electrical junction boxes are commonly used to provide a weatherproof electrical enclosure. However, these electrical junction boxes are typically multi-piece structures that have three or more separate pieces forming the weatherproof enclosure. Furthermore, protective housings or covers for the electrical junction boxes must pass a cold impact test to meet established electrical codes. Thus, these housings usually are constructed of high impact resistant plastics, which are more expensive than non-impact resistant plastics. Additionally, some outlet covers cover a standard electrical junction box in which the outlet is mounted flush with the exterior wall surface. If a hard impact were to break the protective housing, additional protection would not exist for the outlet.

Therefore, a need exists for a covered electrical junction box having minimal components while providing improved protection for the electrical outlet from external impacts.

### SUMMARY

The present invention relates to an electrical junction box that provides improved protection from weather related elements and impact events. The present invention can satisfy the above-mentioned needs by providing an electrical junction box that can receive an electrical device therein and, when installed in a structure, can position the electrical device within an exterior wall of the structure. The electrical junction box can include a transverse wall that can be angularly disposed from the front of the electrical junction box to provide improved moisture protection to the interior of the junction box.

Furthermore, the electrical junction box can include a boss that provides a connection point to an electrical device placed within the junction box. The boss can be supported solely by a back wall of the junction box, without contacting or receiving additional support, from the side walls of the junction box. By positioning the electrical device within the exterior wall and providing an angularly disposed transverse wall along the front edge of the electrical junction box, the electrical device can be better protected from weather-related elements. Positioning the electrical device within the exterior wall also can provide improved protection from impact events along the exterior wall.

In one aspect of the invention, the electrical junction box can include a box-shaped housing. The housing can be made from a single piece of material and can include a back wall and one or more side walls. The side walls can be attached to the back wall along one edge. A front edge of the junction box can be positioned near a second edge of the side walls and can surround a front opening that is opposite the back wall of the housing. The back wall and side walls can define a cavity within the housing. An electrical device can be received within the cavity and can be attached to the housing along one or more bosses. Each boss can extend from a front surface of the back wall of the housing to a position that is recessed from the front edge of the housing. The boss is shaped such that it does not contact or receive structural support from the side wall. The boss further can include a forward facing surface that can receive a fastener for attaching the electrical device to the boss within the electrical junction box. The electrical junction box also can include a transverse wall portion that extends outward from a front edge of the housing.

In another aspect of the invention, the electrical junction box can include a box-shaped housing. The housing can include a back wall and one or more side walls. The side walls can be attached to the back wall along one edge. A front edge of the junction box can be positioned near a second edge of the side walls and can surround a front opening that is opposite the back wall of the housing. A cavity within the housing can be defined by the back wall and side walls. The cavity can be dimensioned to receive an electrical device. The electrical junction box also can include a transverse wall portion that can be attached to one or more of the side walls of the housing. The transverse wall portion can extend angularly outward from an outer surface of the side wall and towards the back wall of the housing.

These and other aspects, objects, features, and advantages of the invention will become apparent to a person having ordinary skill in the art upon consideration of the following detailed description of illustrated exemplary embodiments, which include the best mode of carrying out the invention as presently perceived.

### BRIEF DESCRIPTION OF THE DRAWINGS

For a more complete understanding of the exemplary embodiments of the invention and the advantages thereof, reference is now made to the following description in conjunction with the accompanying drawings which are described as follows.

FIG. 1A is a perspective view of a recessed electrical junction box according to an exemplary embodiment of the present invention.

FIG. 1B is a front view of the exemplary electrical junction box of FIG. 1A.

FIG. 1C is a side view of the exemplary electrical junction box of FIG. 1A.

FIG. 1D is a bottom view of the exemplary electrical junction box of FIG. 1A.

FIG. 1E is a rear view of the exemplary electrical junction box of FIG. 1A.

FIG. 1F is an interior view of the exemplary electrical junction box of FIG. 1A, further including free bosses according to an exemplary embodiment of the present invention.

FIG. 1G is an interior view of the exemplary electrical junction box of FIG. 1A, further including integral bosses according to an exemplary embodiment of the present invention.

FIG. 1H is an interior view of the exemplary electrical junction box of FIG. 1A further including an electrical device according to an exemplary embodiment of the present invention.

FIG. 1I is a sectional view of the exemplary electrical junction box of FIG. 1H.

FIG. 1J is another sectional view of the exemplary electrical junction box of FIG. 1H.

FIG. 2A is perspective view of a recessed electrical junction box according to an alternative exemplary embodiment of the present invention.

FIG. 2B is a front view of the exemplary electrical junction box of FIG. 2A.

FIG. 2C is a sectional view of the exemplary electrical junction box of FIG. 2A, further including an electrical device according to an exemplary embodiment of the present invention.

FIG. 3A is perspective view of a recessed electrical junction box according to an another alternative exemplary embodiment of the present invention.

FIG. 3B is a front view of the exemplary electrical junction box of FIG. 3A.

FIG. 3C is a side view of the exemplary electrical junction box of FIG. 3A.

FIG. 4A is perspective view of a recessed electrical junction box according to another alternative exemplary embodiment of the present invention.

FIG. 4B is a front view of the exemplary electrical junction box of FIG. 4A.

FIG. 4C is a side view of the exemplary electrical junction box of FIG. 4A.

FIG. 5A is perspective view of a recessed electrical junction box according to yet another alternative exemplary embodiment of the present invention.

FIG. 5B is a front view of the exemplary electrical junction box of FIG. 5A.

FIG. 5C is a side view of the exemplary electrical junction box of FIG. 5A.

### DETAILED DESCRIPTION OF THE INVENTION

The present application relates to recessed electrical junction boxes that secure an electrical device substantially within the exterior of a building structure for accommodating and protecting a duplex outlet or other electrical device therein. The recessed electrical junction box has features that allow it to be easily recessed to the correct depth on either a new building or an existing building. It can be installed on a new building having unfinished walls, in which the finishing surface, such as siding, stucco, or brick, will be installed subsequently, or as a retrofit on an existing building.

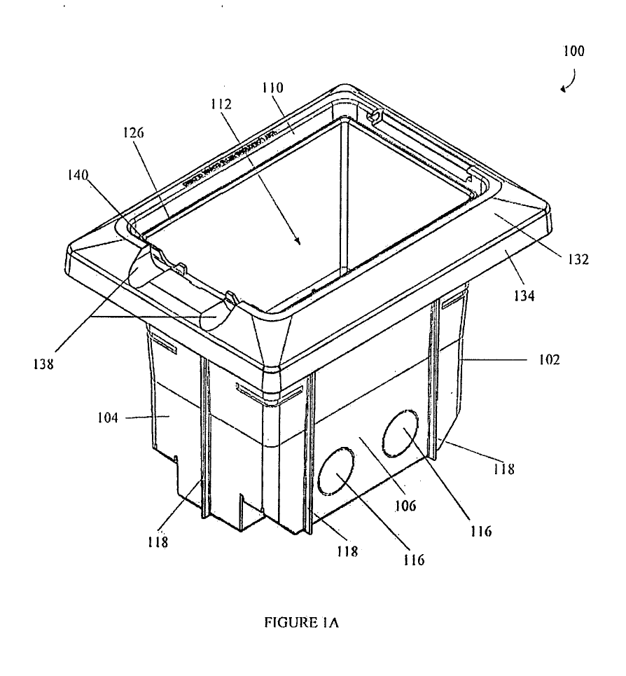

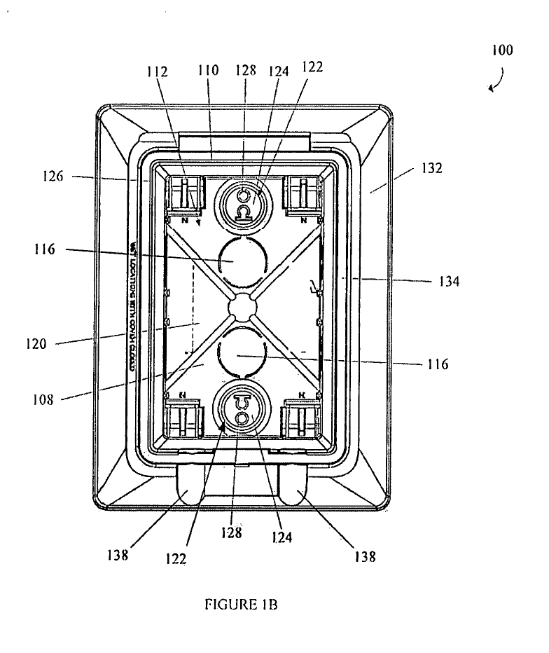

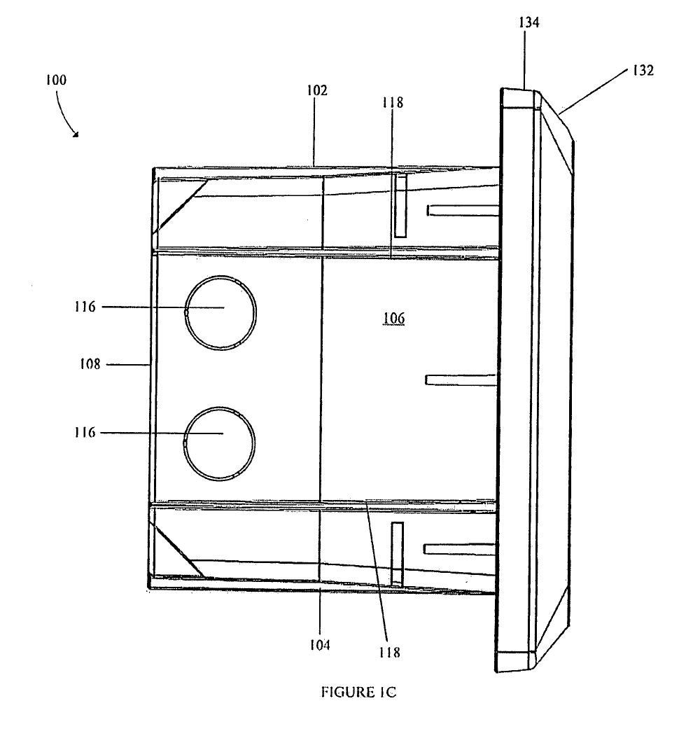

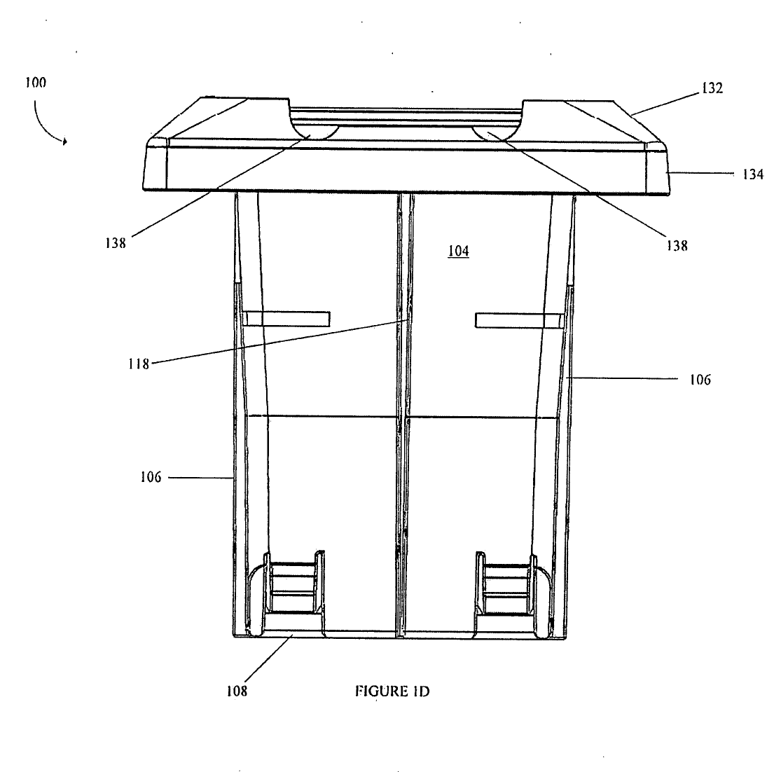

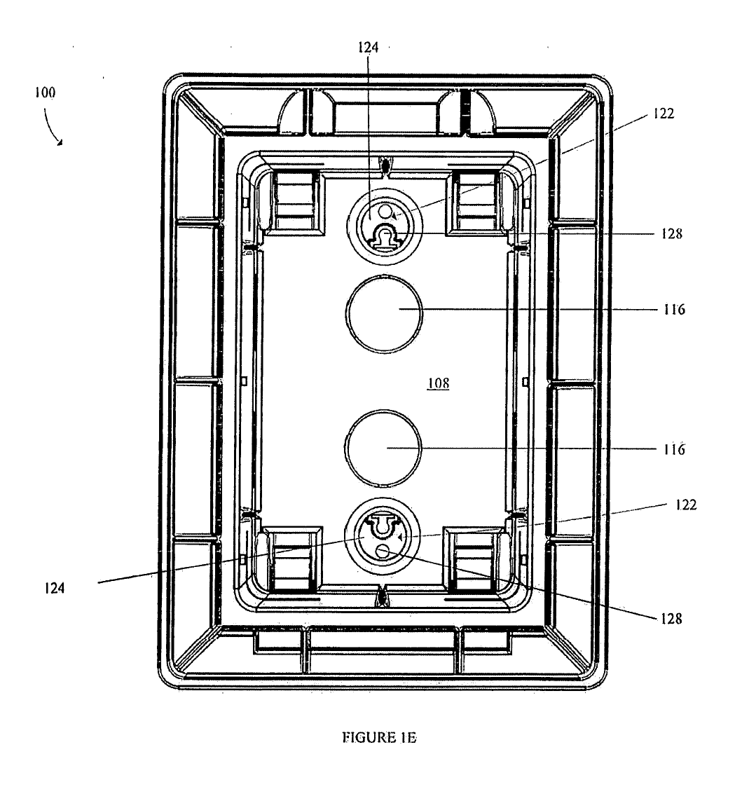

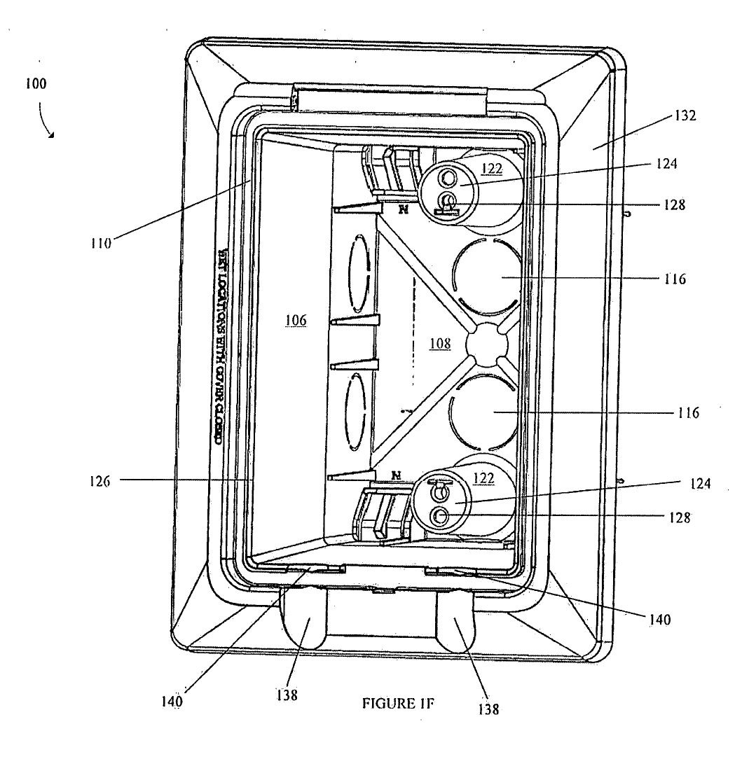

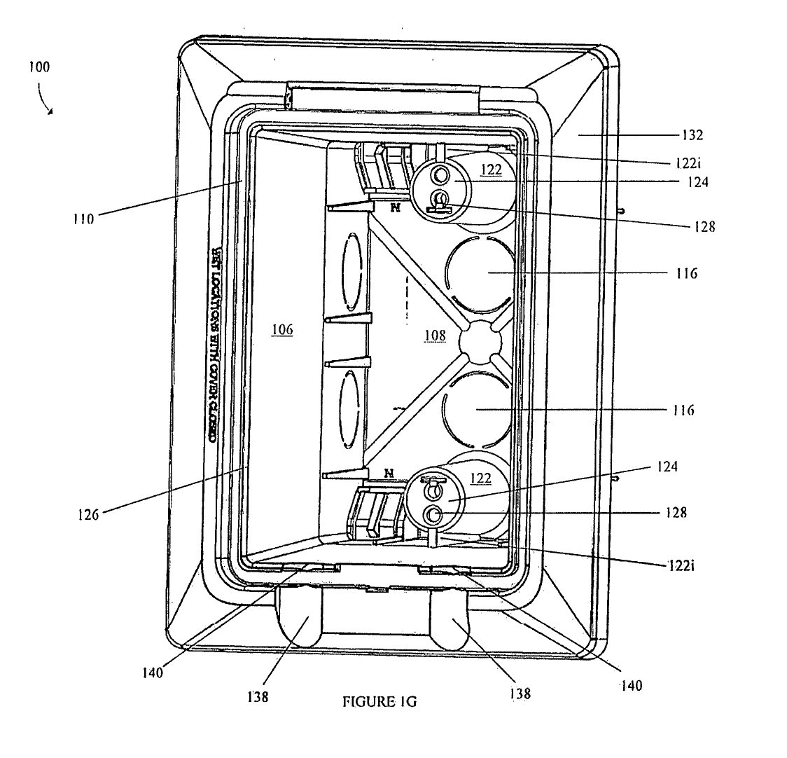

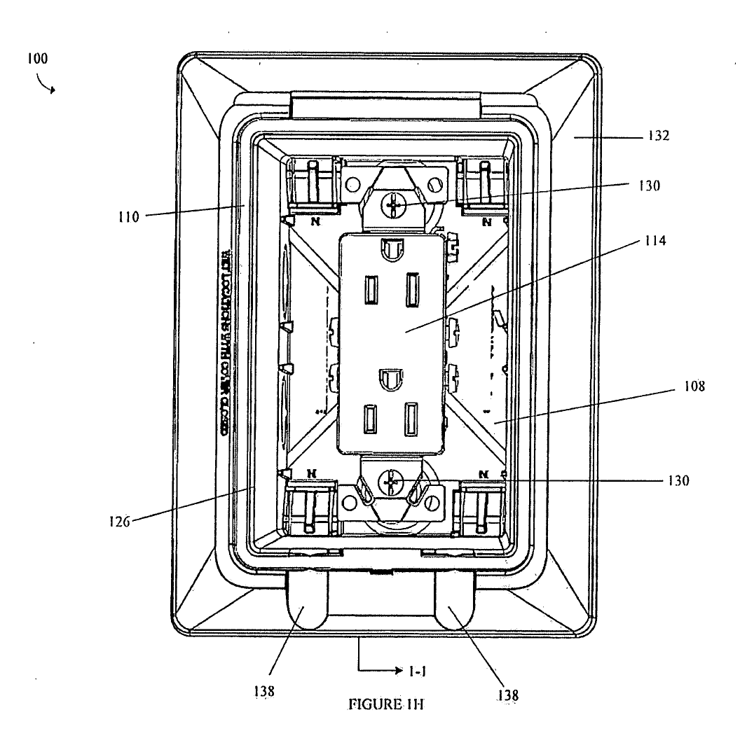

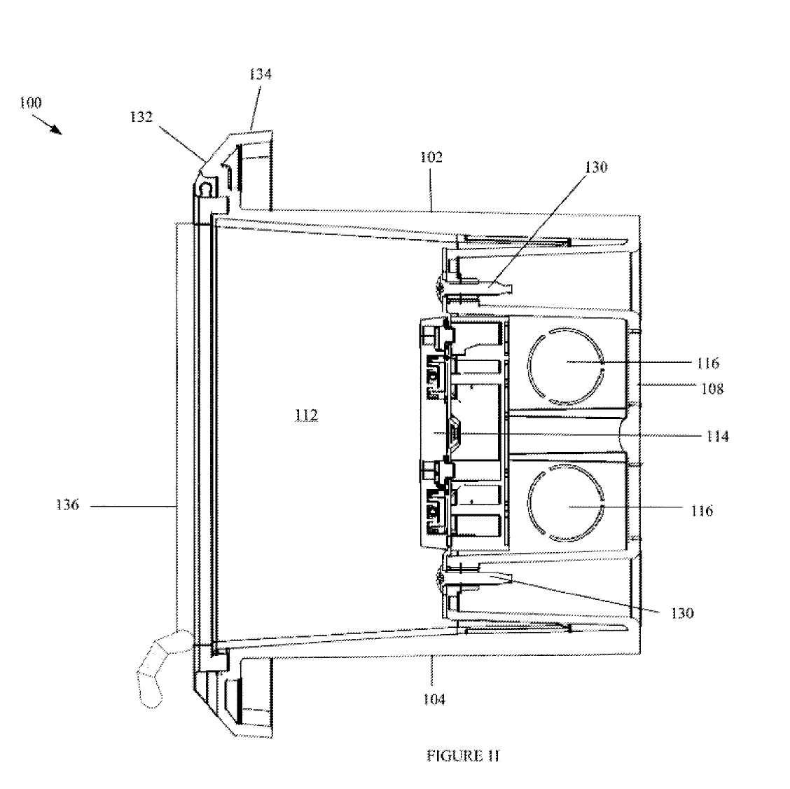

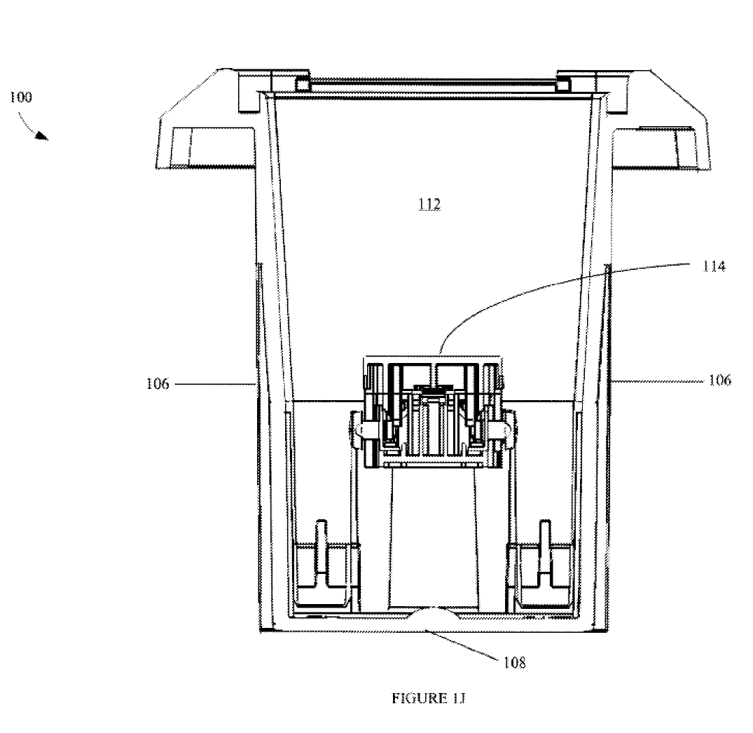

Referring to FIGS. 1A-1J, an electrical junction box 100 according to one exemplary embodiment of the present invention is shown and described. The electrical junction box 100 includes a box-shaped housing having a top wall 102, a bottom wall 104, side walls 106 (hereinafter, the top wall, bottom wall, and side walls may collectively be referred to as “side walls(s)”), a back wall 108, and a front opening 110. In one exemplary embodiment; the box-shaped housing is made from a unitary piece of material, such as molded plastic. The back wall 108 and side walls 102, 104, 106 define a cavity 112 for receiving an electrical device. In one exemplary embodiment, the electrical device can be an outlet 114. In an alternative exemplary embodiment, the electrical device can be a switch.

In another exemplary embodiment, the back wall 108 and/or the side walls 106 may include one or more removable wall portions or knockouts 116, which may be removed to provide a passage for wiring (not shown) into or out of the electrical junction box 100. A plurality of ribs 118 also may be included along the exterior or interior surface of the top wall 102, the bottom wall 104, and/or the side walls 106. In one exemplary embodiment, the ribs 118 extend from about the front opening 110 to the back wall 103 along the exterior surface of one or more of the side walls 102, 104, 106. The ribs 118 can improve the strength and durability of the side walls 102, 104, 106.

The back wall 108 includes a front surface 120 from which two bosses 122 extend into the cavity 112. In one exemplary embodiment, the bosses 122 extend freely from the front surface 120 of the back wall 108 into the cavity 112 without touching or receiving support from the side walls 102, 104, 106, as shown in FIG. 1F. In an alternative exemplary embodiment, the bosses 122 also are integral to one or more of the side walls 102, 104, 106 via a support 122i that extends from each boss 122 to the corresponding side wall 102, 104, 106, as shown in FIG. 1G. Each boss 122 includes a forward facing surface 124 that is recessed from a front edge 126 surrounding the front opening 110. In one exemplary embodiment, the boss 122 is recessed a distance greater than the depth of the electrical device at the point of attachment. The forward facing surfaces 124 include apertures 128 for receiving fasteners 130 for coupling the electrical device to the electrical junction box 100. The apertures 128 may be smooth bores or threaded bores capable of receiving the fasteners 130.

A transverse wall portion 132 extends outwardly from the front edge 126 of the front opening 110. In certain exemplary embodiments, the transverse wall portion 132 extends orthogonally from the front edge 126. In other exemplary embodiments, the transverse wall portion 132 extends angularly out from the side walls 102, 104, 106 and towards the back wall 108. In certain exemplary embodiments, the transverse wall portion 132 further includes a second wall portion 134 that extends from the outer edge of the transverse wall portion 132 in a direction substantially orthogonal to a plane parallel to the back wall 108.

In one exemplary embodiment, the electrical junction box 100 is integrally molded in one piece and formed by injection molding of plastic. Suitable examples of plastic include, but are not limited to, polyvinyl chloride, polyethylene, and polypropylene. In alternative embodiments, the electrical junction box 100 may be formed separately of metal or plastic and secured together by conventional means such as screws, nuts, welding, and adhesives to form the electrical junction box 100.

As shown in FIG. 1I, the exemplary electrical junction box 100 also includes a cover 136 for closing the front opening 110 of the box and preventing access to the cavity 112. The cover 136 is rotatably connected to the transverse wall portion 132 and telescopes into the transverse wall portion 132. In an alternative exemplary embodiment, the cover 136 is rotatably coupled to one of the side walls 102, 104, 106. In one exemplary embodiment, the cover 136 is constructed of high impact-resistant plastic.

The electrical junction box 100 also includes one or more recesses 138 in the transverse wall portion 132 for electrical cords (not shown) to run from the outlet 114 to the outside of the electrical junction box 100 while the cover 136 is in a closed position. In certain exemplary embodiments, the front edge 126 of the recessed electrical junction box 100 also includes one or more recesses, for example, U-shaped slots 140, and the cover 136 also includes one or more recesses, such as U-shaped slots (not shown). When the cover 136 is rotatably connected to the electrical junction box 100 and the cover 136 is in a closed position, preventing access to the cavity 112 from the exterior of the electrical junction box 100, the U-shaped slots 140 of the front edge 126 aligns with the U-shaped slots of the cover 136, thereby providing a substantially circular cord opening therein. The cord openings thereby form a passageway for electrical cords to remain connected to the electrical outlet within the electrical junction box 100 with the cover 136 closed thereon, while still providing weatherproof protection to the electrical devices therein. In an alternative exemplary embodiment, the depth of the recess 140 is increased, such that the recess is capable of receiving an electrical cord when the cover 136 is closed without the cover also including a recess.

When the electrical junction box 100 is mounted on a building with the cord openings oriented vertically downward, the recessed electrical junction box 100 creates a weatherproof electrical junction box that effectively shields the electrical device from rain and other elements. Additionally, because the recessed electrical junction box 100 positions an electrical device substantially behind a wall surface, additional protection is provided to the electrical device from any hard impacts capable of breaking the protective cover 136.

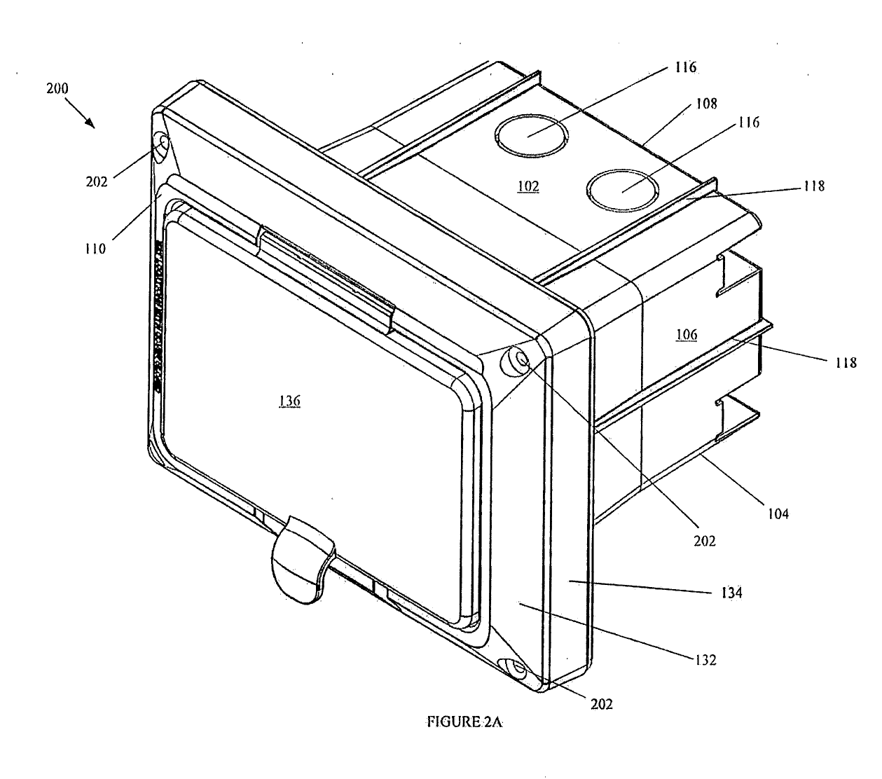

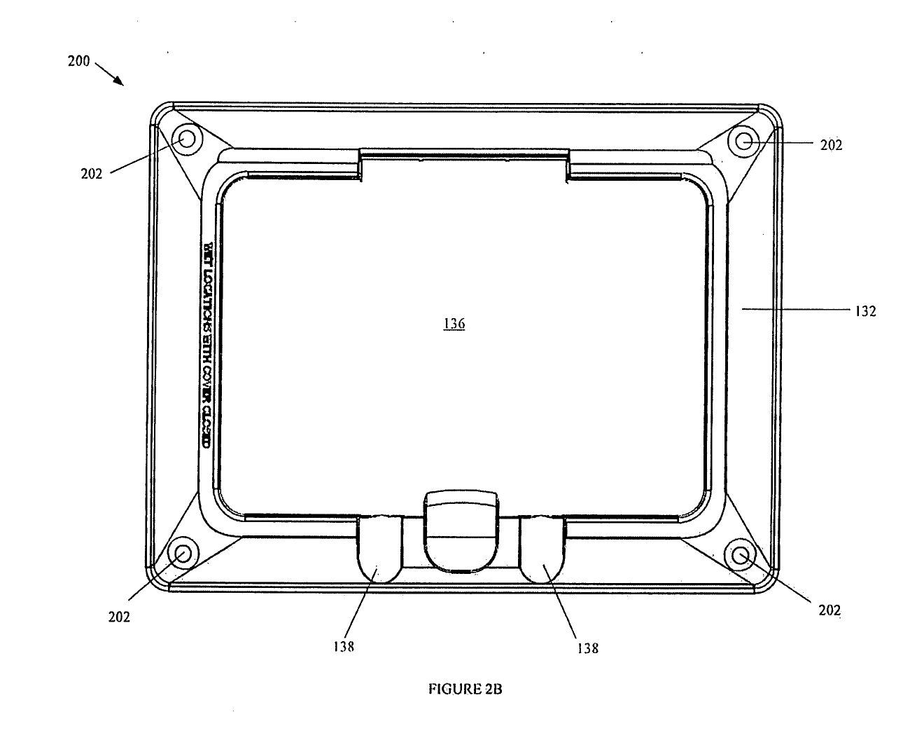

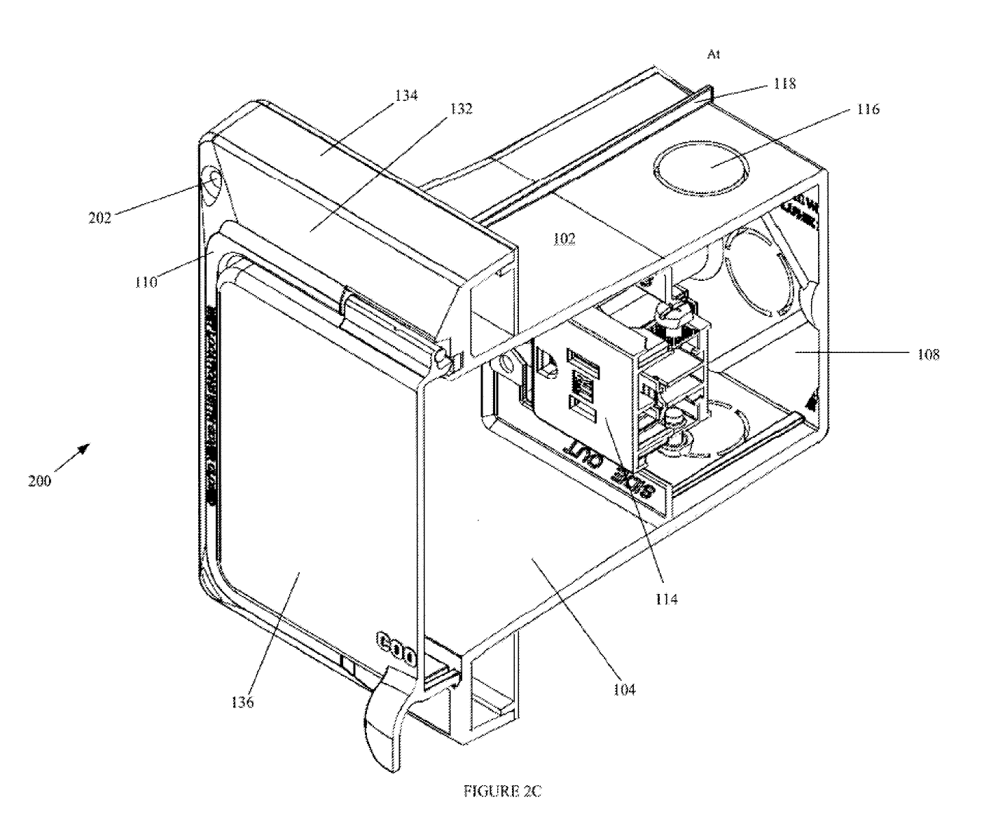

FIGS. 2A-2C illustrate an electrical junction box 200 according to an alternative exemplary embodiment of the invention. The electrical junction box 200 is similar to the electrical junction box 100 of FIGS. 1A-1J except as set forth below. The electrical junction box 200 includes one or more holes 202 in and extending through the transverse wall portion 132. Fasteners may be placed through the holes 202 to couple the electrical junction box 200 to an existing building structure (not shown). In addition, the electrical junction box 200 is shown in a horizontal configuration.

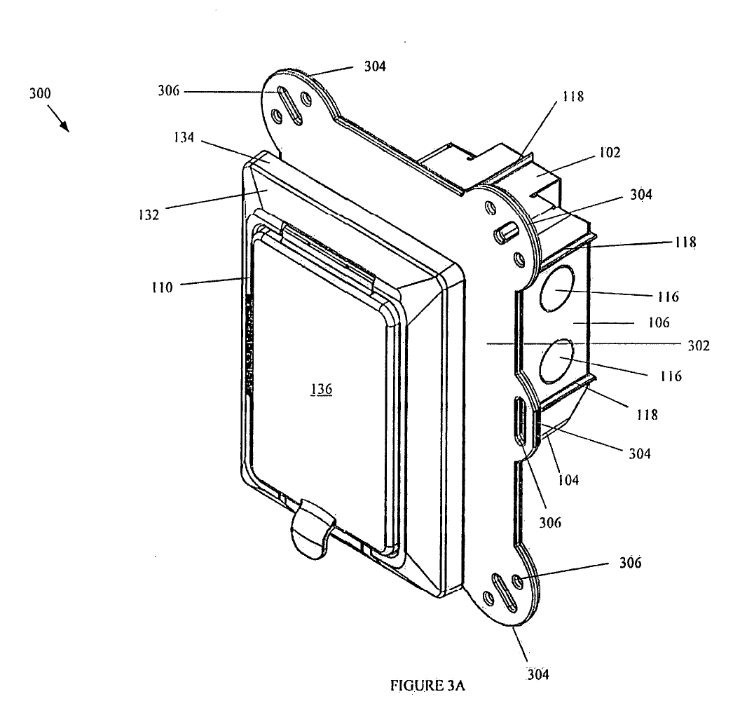

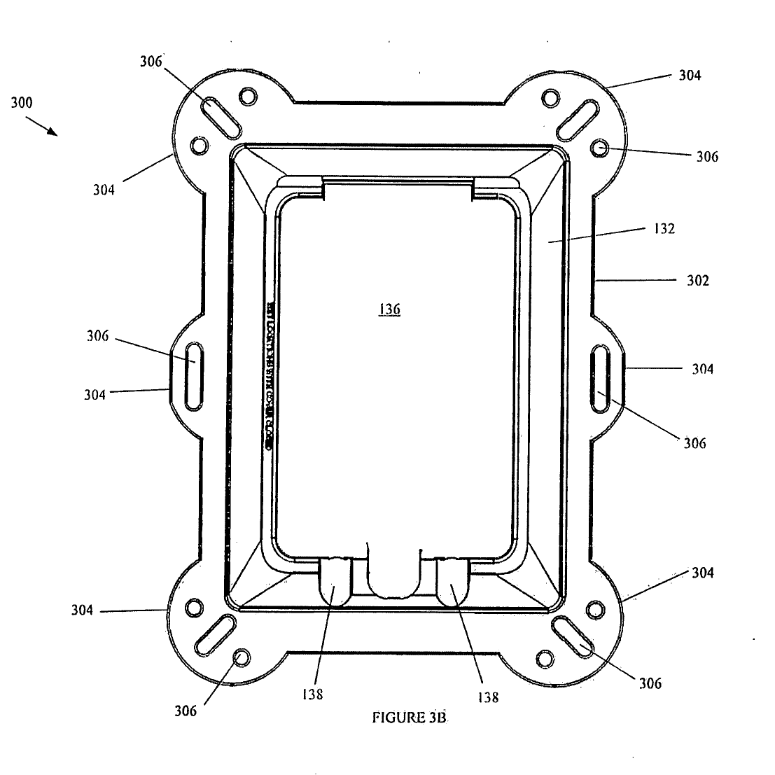

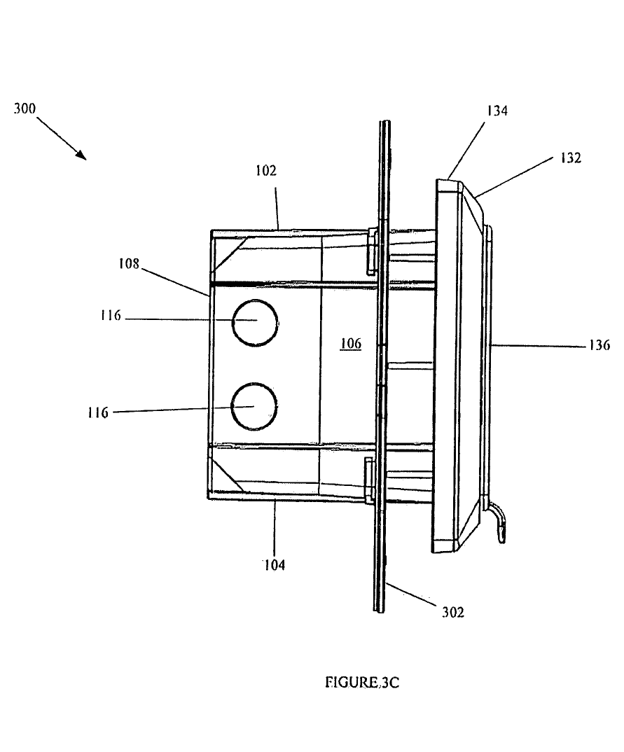

FIGS. 3A-3C illustrate an electrical junction box 300 according to another alternative exemplary embodiment of the present invention. Electrical junction box 300 is similar to electrical junction box 100 of FIGS. 1A-1J except as set forth below. Referring now to FIGS. 3A-3C, the exemplary, electrical junction box 300 includes a flange 302. In one exemplary embodiment, the flange 302 extends continuously outwardly from and substantially orthogonal to the outer surfaces of the top wall 102, bottom wall 104, and side walls 106 in a spaced-apart-orientation from the second wall portion 134. The flange 302 includes one or more ear-shaped extensions 304. The ear-shaped extensions 304 include holes or slots 306, where fasteners (not shown) are placed therethrough to couple the electrical junction box 300 to a building structure (not shown). In one exemplary embodiment, the electrical junction box 300 is used with a structure having a vinyl siding exterior. In this embodiment, the vinyl siding and insulation are positioned between the flange 302 and the second wall portion 134. In one exemplary embodiment, the flange 302 may be detached or slidably removable from the electrical junction box 300.

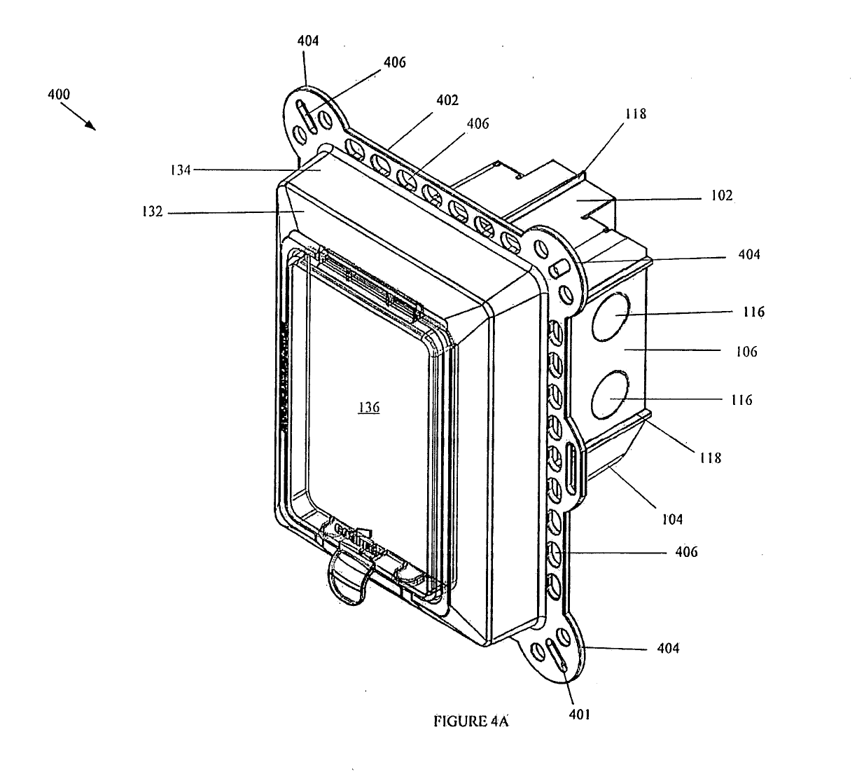

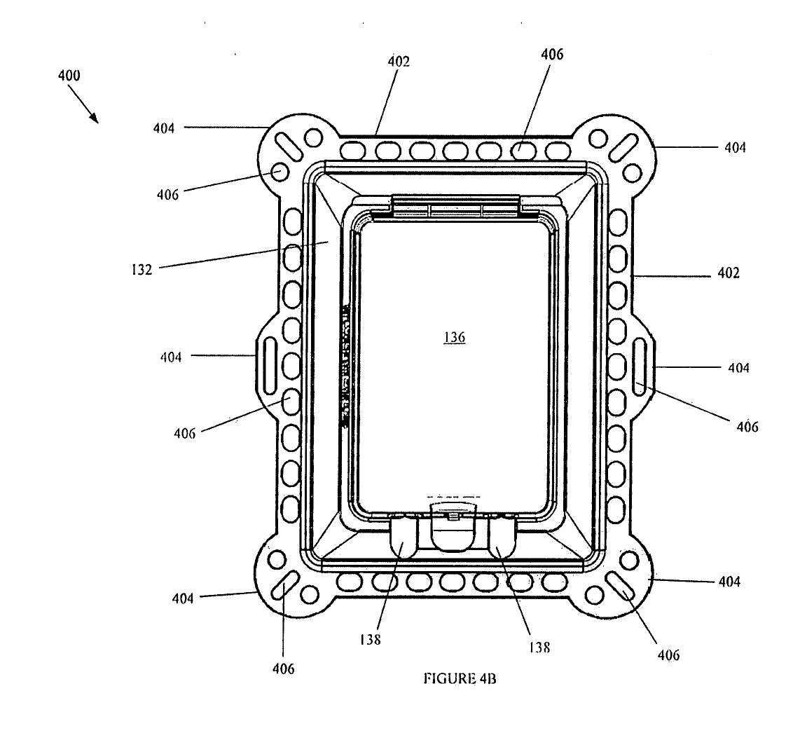

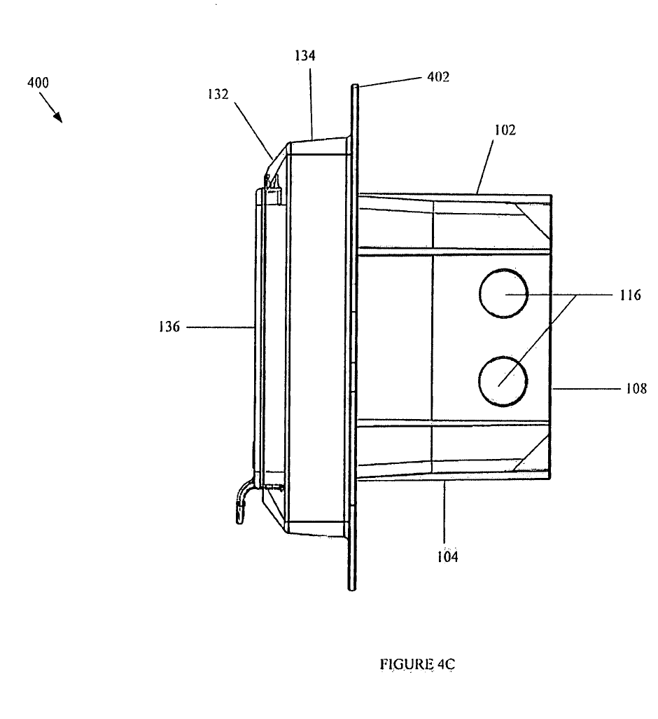

FIGS. 4A-4C illustrate an electrical junction box 400 according to another alternative exemplary embodiment of the present invention. Electrical junction box 400 is similar to electrical junction box 100 of FIGS. 1A-1J except as set forth below. Referring now to FIGS. 4A-4C, the exemplary electrical junction box 300 includes a flange 402 extending outwardly from and substantially orthogonal to the second wall portion 134. The flange 402 also includes one or more car-shaped extensions 404. Each ear-shaped extension 404 includes holes or slots 406, where fasteners (not shown) may be positioned therethrouugh and used to couple the electrical junction box 400 to a building structure (not shown). In one exemplary embodiment, the electrical junction box 400 is used with a structure having a stucco exterior layer. In this embodiment, the stucco layer may be applied over the flange 402.

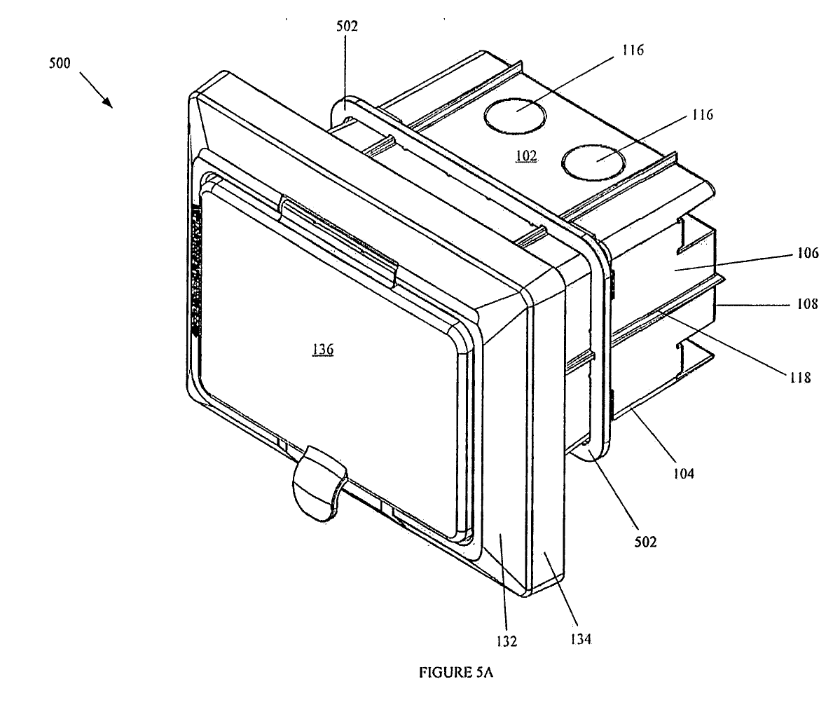

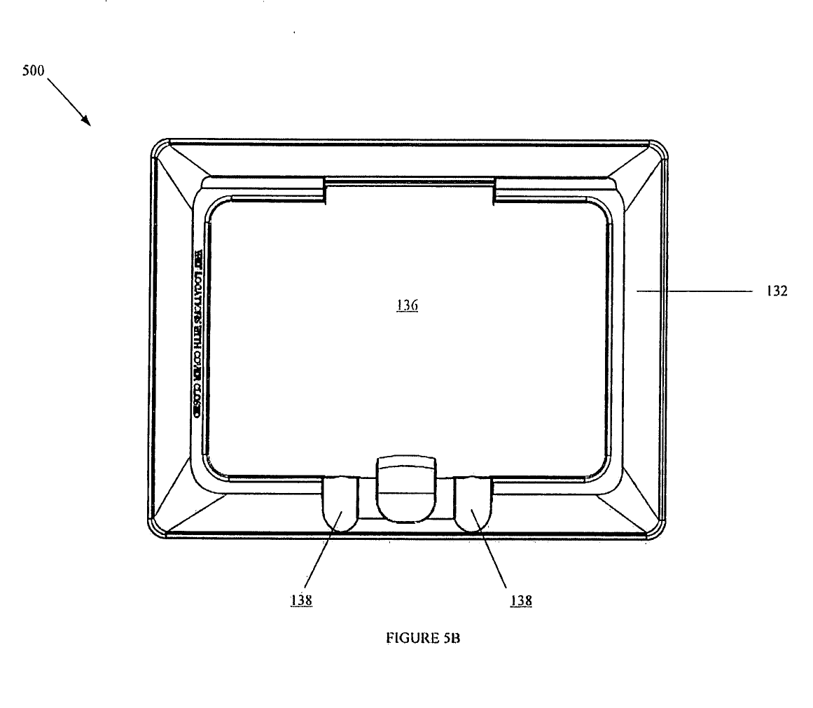

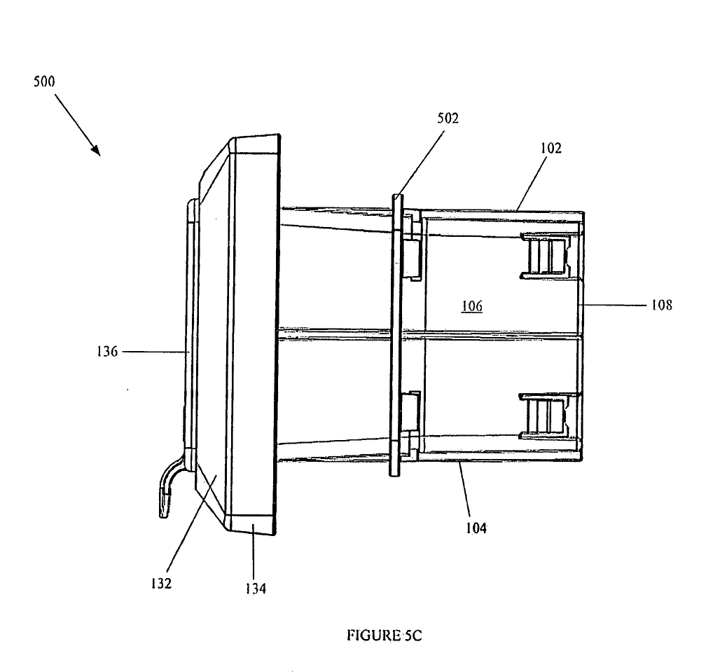

FIGS. 5A-5C illustrate an electrical junction box 500 according to another alternative exemplary embodiment of the present invention. Electrical junction box 500 is similar to electrical junction box 100 of FIGS. 1A-1J except as set forth below. Referring now to FIGS. 5A-5C, the exemplary electrical junction box 500 includes a flange 502 that extends outwardly from and substantially orthogonal to the outer surfaces of the top wall 102, bottom wall 104, and side walls 106 in a spaced apart orientation from the second wall portion 134. In one exemplary embodiment, the flange 502 is a continuous piece that is detachable from the electrical junction box 500. In one exemplary embodiment, the electrical junction box 500 is used in a building structure having a brick exterior (not shown). In this embodiment, adjacent bricks are positioned between the flange 505 and the second wall portion 134.

As described herein, the invention is well adapted to attain the ends and advantages mentioned, as well as those that are inherent therein. The particular embodiments disclosed above are illustrative only, as the present invention may be modified and practiced in different but equivalent manners apparent to those of ordinary skill in the art having the benefit of the teachings provided herein. Having described some exemplary embodiments of the present invention, it is believed that the use of alternative electrical junction boxes having similar physical features is within the purview of those having ordinary skill in the art. For example, the holes or apertures in the transverse wall portion and/or flanges may be spaced apart varyingly. Also, any holes or apertures may include slots as well as circular openings. Additionally, while the present application illustrates generally rectangular electrical junction boxes, it is understood that a number of other non-rectangular configurations may be used and the electrical junction box may be configured correspondingly, while still being able to house the receptacle.

Any spatial references herein such as, for example, “top,” “bottom,” “upper,” “lower,” “above,” “below,” “rear,” “between,” “vertical,” “angular,” “beneath,” etc., are for the purpose of illustration only and do not limit the specific orientation or location of the described structure.

While numerous changes may be made by those having ordinary skill in the art, such changes are encompassed within the spirit and scope of this invention as defined by the appended claims. Furthermore, no limitations are intended to the exemplary details of construction or design herein shown, other than as described in the claims below. It is therefore evident that the particular illustrative embodiments disclosed above may be altered or modified and all such variations are considered within the scope and spirit of the present invention as defined by the claims below.

What is claimed is:

1. An electrical junction box for housing an electrical device, comprising:
a unitary box-shaped housing comprising a back wall, at least one side wall each comprising a first edge and a second edge opposite the first edge wherein each of the at least one side wall is coupled to the back wall along the first edge, a front opening opposite the back wall, a front edge adjacent the second edge of the at least one side wall and positioned about the front opening, and a cavity defined by the back wall and the at least one side wall, wherein the back wall and the at least one side wall each comprise an inner surface and an outer surface;
a boss extending from the inner surface of the back wall into the cavity without contact or support from the at least one side wall, wherein the boss comprises a forward facing surface recessed from the front opening, the forward facing surface being configured to receive a fastener; and
a transverse wall portion coupled to the at least one side wall and extending from the outer surface of the at least one side wall along a periphery of the front edge.

2. The electrical junction box of claim 1, further comprising a second wall portion coupled to and extending orthogonally from the transverse wall portion.

3. The electrical junction box of claim 2, further comprising a flange coupled to and extending radially outward from the second wall portion, wherein the flange comprises a plurality of apertures.

4. The electrical junction box of claim 1, further comprising a cover rotatably coupled to the transverse wall portion, wherein the cover is rotatable from a first position to a second position, wherein the first position prevents access to the cavity from a location exterior to the electrical junction box and wherein the second position allows access to the cavity from the location exterior to the electrical junction box.

5. The electrical junction box of claim 4, wherein the cover telescopes into: the transverse wall portion.

6. The electrical junction box of claim 1, further comprising a flange extending orthogonally away from the outer surface of the at least one side wall, wherein the flange comprises a plurality of apertures.

7. The electrical junction box of claim 5, wherein the flange is detachably coupled to the at least one side wall.

8. The electrical junction box of claim 1, wherein the transverse wall portion further comprises a plurality of apertures.

9. The electrical junction box of claim 1, further comprising a second boss extending from the inner surface of the back wall into the cavity without contact or support from the side wall and comprising a forward facing surface recessed from the front opening and configured to receive a fastener.

10. The electrical junction box of claim 1, wherein the forward facing surface of the boss comprises an aperture for receiving the fastener.

11. The electrical junction box of claim 1, wherein the housing comprises four side walls.

12. The electrical junction box of claim 1, wherein the housing comprises a substantially circular side wall.

13. An electrical junction boxy for housing an electrical device, comprising:
a box-shaped housing comprising a back wall, at least one side wall each comprising a first edge and a second edge opposite the first edge wherein each of the at least one side, wall is coupled to the back wall along the first edge, a front opening opposite the back wall and adjacent the second edge of the at least one side wall, a front edge adjacent the second edge of the at least one side wall and positioned about the front opening, and a cavity defined by the back wall and the at least one side wall, wherein the back wall and the at least one side wall each comprise an inner surface and an outer surface; and
a transverse wall portion coupled to the at least one side wall and extending angularly from the outer surface of the at least one side wall and towards the back wall of the housing.

14. The electrical junction box of claim 13, further comprising a second wall portion coupled to and extending orthogonally from the transverse wall portion, wherein the transverse wall portion extends angularly between the side wall and the second wall portion.

15. The electrical junction box of claim 14, further comprising a flange coupled to the second wall portion and extending away from side wall, wherein the flange comprises a plurality of apertures to couple the electrical junction box to a structure.

16. The electrical junction box of claim 13, further comprising a cover rotatably coupled to the transverse wall portion, wherein the cover is rotatable from a first position to a second position, wherein the first position prevents access to the cavity from a location exterior to the electrical junction box and wherein the second position allows access to the cavity from the location exterior to the electrical junction box.

17. The electrical junction box of claim 13, further comprising a flange positioned about and extending away from the outer surface of the side wall, wherein the flange comprises a plurality of apertures to couple the flange to a structure.

18. The electrical junction box of claim 17, wherein the flange is detachably coupled to the side wall.

19. The electrical junction box of claim 13, wherein the transverse wall portion further comprises a plurality of apertures for coupling the electrical junction box to a structure.

20. The electrical junction box of claim 13, further comprising at least one boss extending from the inner surface of the back wall into the cavity without contact or support from the side wall, wherein the boss comprises a forward facing surface recessed from the front opening for receiving a fastener to couple the housing to the electrical device.

21. The electrical junction box of claim 13, wherein the forward facing surface of the boss comprises an aperture for receiving the fastener.

22. The electrical junction box of claim 13, wherein the housing comprises four side walls.

23. The electrical junction box of claim 13, wherein the housing comprises a substantially circular side wall.
